(19) United States
(12) Patent Application Publication
(10) Pub. No.: US 2003/0208378 A1
(43) Pub. Date: Nov. 6, 2003

(54) Clincal trial management

(76) Inventors: Venkatesan Thangaraj, Watertown, MA (US); Somashekar N Reddy, Tyngsboro, MA (US)

Correspondence Address: SILICON VALLEY INTELLECTUAL PROPERTY GROUP, P.O. BOX 721120, SAN JOSE, CA, 95172-1120, US

(21) Appl. No.: 10/296,827

(22) PCT Filed: May 25, 2001
(86) PCT No.: PCT/US01/17214

(51) Int. Cl. G06F 17/60

(52) U.S. Cl. 705/2

(57) ABSTRACT

An Internet-based clinical trial management center (FIG. 1) that communicates with a base of users (12), participating in a clinical trial and enables the users to access and manage data (49), as well as obtain the products of data processing (40), according to each user's role in the clinical trial. The management center (40) captures data from different data sources, that is, user-operational devices, and transforms the data into a common format for storage in a database (49). Data processed by the management center (40) is converted from the common format to one suitable for a receiving device operated by the user (12) who is to receive the data. At a workflow level, the management center implements a clinical data interchange pipeline (CDIP) to allow data to be transported in a flow in a given direction and intercepted throughout its flow for processing by applications having different formats and transport protocols in a seamless manner.

### TECHNICAL FIELD

This invention relates to managing the performance of clinical trials and development for medical products.

### BACKGROUND

The United States Food and Drug Administration (FDA) requires that medical companies, such as pharmaceutical and device companies, conduct extensive clinical trial research to demonstrate the clinical efficacy, safety, and medical advantage of their products (e.g., medical devices such as surgical instruments and implants, and pharmaceuticals) before it will give permission to distribute the products in the U.S. Pharmaceutical companies, for example, invest millions of dollars conducting clinical trials on a number of likely drug candidates in the hope that, while many will fail, at least one will be a “blockbuster” with multi-billion dollar sales. Of the several thousand agents currently undergoing trials, statistics indicate that only a small percentage will receive FDA approval.

Efforts to streamline the development and clinical trial process are attractive to pharmaceutical sponsors because they maximize the upfront investment dollar, permitting the support of a greater number of drug candidates, and can greatly increase the return on that investment on the back end through increased sales under the company's patent rights. There are outside pressures as well. The FDA itself is pressuring industry to streamline the drug development process, and has mandated that all pharmaceutical companies be in position to submit trial information electronically by 2002. This mandate has been referred to as the “Y2K of the pharma industry.”

In order to better prevent the commercialization of unsafe drugs and devices, the FDA is searching for methods that will increase the number of patients enrolled in pharmaceutical and medical device clinical trials in an economic manner. To date, the pharmaceutical industry—and to a lesser extent, the device industry—has responded to the need to accelerate the clinical trial process by outsourcing the project to dedicated contract research organizations (CROs). These organizations offer trained labor and economies of scale to address trial design and management. The industry as a whole, however, retains the traditional and inefficient paper-based methods of recording, faxing, and storage of data. Early data management solutions have been limited, and have consisted of proprietary, client-server, or offline databases. Many pharmaceutical and device companies have one or more of these so-called “legacy” systems in-house.

### SUMMARY

This invention features an Internet-based solution to clinical trial management.

In one aspect, the invention provides methods and apparatus, including computer program products, for managing a clinical trial. The methods include enabling information exchanges over an Internet-based network with users participating in a clinical trial, deploying over the Internet-based network for use by the users clinical trial setup information including tools to automate creation of a data repository, providing to the users collaborative clinical trial setup and administration functions which allow the users to use the clinical trial setup information to collaborate with each other and administer the clinical trial, and performing clinical trial management functions to add intelligence to clinical trial data received in the information exchanges.

Embodiments of the invention may include one or more of the following features.

The clinical trial data can be captured in different formats from a plurality of data sources, transformed to a common format for storage in the data repository and converted from the common format to another format suitable for a receiving device operated by a user to receive such clinical trial data.

Provided are processing nodes that share a common interface and are adapted to communicate with applications having different interfaces. The processing nodes can be organized into a pipeline structure to support a flow of clinical data objects in a given direction. Each processing node within the pipeline structure uses the common interface to allow the flow of the clinical data objects to be directed out of the pipeline to one of the applications for processing and reintroduced into the pipeline structure through that node.

Customization of workflow related to processing of the clinical trial data by the user is enabled.

Clinical trial parameters can be defined to denote aspects of clinical trial performance and updated during the clinical trial on a real-time basis.

Each user can be associated with a username, password, clinical trial role and site. The username and password can be used to validate the user for authentication at a level of data access. The clinical trial role and site can be used to validate the user for authentication at different level of data access.

Audit trails can be generated to track changes in the clinical trial data.

In another aspect, the invention provides methods and apparatus for operating a medical imaging system in a clinical environment having a clinical trial server for storing clinical trial data from users participating in a clinical trial. The methods include communicating with the clinical trial server to download images from among the stored clinical trial data, authenticating users into the clinical trial system based on user privileges associated with the users, analyzing the images and providing results of the analyzing to the clinical trial server over a secure Internet link for integration with the stored clinical trial data.

In yet another aspect, the invention provides a clinical management system including an arrangement of servers capable of responding to user request from users participating in a clinical trial. The arrangement is scalable to serve an increasing number of the users concurrently by coupling additional servers, and maintains user session information in a database tier to provide for load sharing between at least two of the servers.

Particular implementations of the invention may provide one or more of the following advantages. The clinical trial management system of the invention provides a base of users that participate in the clinical trial with a comprehensive clinical trial solution that enables each user to enter, retrieve, and manage data, as well as obtain the products of data processing (e.g., in the form of reports) according to that user's role in the clinical trial. In addition, because it is Internet-based, the system provides the user base with access to ancillary services useful in conducting the clinical trial, for example, data assembly and verification, and access to help, educational, and other commercial on-line services.

Moreover, its various features cooperate to dramatically increase the efficiency of clinical trial management while, at the same time, maintaining a high level of user/data security. For example, each user is provided with collaborative clinical trial setup and administration functions enabling that user to collaborate with other users involved in a clinical trial. Each user is assigned a clinical trial role and is allowed to use a given clinical management function (as well as control the parameters of that use) based on the assigned role.

The architecture of the system is extremely flexible and scalable. Functional components are distributed among multiple servers, which need not be located physically closely to one another, and may in fact be widely separated geographically. The servers may be linked by, e.g., a private network such as an intranet, or through the Internet. The architecture is implemented as a tiered architecture and thus allows clinical trial management functionality to be distributed across different machines or servers.

The system also allows data to be captured from and provided to a number of different data sources regardless of data format. For example, data can be captured from a wide variety of user-operated devices (e.g. web browsers, PDAs, legacy systems, and IVR/FAX devices), and normalized for storage in a database. Similarly, data produced by various processing modules (e.g., reports) is converted from the common format to one suitable for a receiving device operated by the user who is to receive the data (e.g., a web browser, etc.). The reformatted data is then sent to the user, e.g., via the Internet

The clinical data interchange feature of the system allows clinical trial participants to exchange information electronically in a seamless manner. The CDIP packages and transports clinical data objects from one application to another over any communication network used by the system. The pipeline structures also allows data to be intercepted throughout its flow in the system for value added processing by applications having different data formats and transport protocols.

Other features and advantages of the invention will be apparent from the detailed description and drawings and from the claims.

### DESCRIPTION OF DRAWINGS

FIG. 1 illustrates an Internet-based system for managing a clinical trial.

FIG. 2 shows features of a clinical trial portal.

FIG. 3 depicts a process for creating system users.

FIG. 4 shows a user login process.

FIG. 5 illustrates a basic network topology of the system.

FIGS. 6 and 7 are useful in understanding the architecture of the system.

FIG. 8 illustrates how the system receives data from and transmits data to different types of data sources and destinations.

FIG. 9 illustrates how the system transforms large amounts of data into more useful, intelligent information.

FIG. 10 shows a data flow pipeline architecture.

Like reference symbols in the various drawings indicate like elements.

### DETAILED DESCRIPTION

A. Introduction

As discussed above, the FDA requires that medical companies such as pharmaceutical and medical device manufacturers conduct extensive clinical trial research to demonstrate to FDA reviewers the clinical efficacy, safety, and medical advantage of their products before they can be marketed in the U.S. The FDA-mandated clinical trial process requires tracking, date-stamping, and coordination of hundreds of thousands of discrete data points from a number of independent sources and across many formats, including case report forms, patient charts, laboratory tests, medical images, etc. Management of this process represents a significant cost in terms of both time and money.

Medical companies have great incentive to accelerate the clinical trial enrollment process. For example, pharmaceutical companies must complete clinical testing, apply for and receive FDA approval, and successfully market their drug within the span of their agent's patent life, after which they may lose much of their market share and profitability to generic equivalents. The upfront investment is high; pharmaceutical companies invest approximately $22 billion annually in clinical trials. However, the payoff can be high as well; the average approved drug on the market can drive approximately $1 million/day at peak sales, and blockbuster drugs like Prilosec™ and Zocar™ can provide in excess of $10 million/day.

Pharmaceutical clinical trials are risky investments. A significant percentage of trials, either due to inherent failings in the agent-under-investigation or to flawed trial protocols, fail to demonstrate sufficient medical utility. Currently, pharmaceutical companies invest millions of dollars in likely product candidates in the hope that, while most may fail, at least one will be a “blockbuster” with multi-million dollar sales, providing a positive return on investment for the company's R&D efforts. Only a very few compounds receive a drug license from the FDA, and less than 30% of new compounds recover the cost of development. Solutions that minimize the upfront investment are attractive to the development organizations because they permit the support of a greater number of drug candidates and can greatly increase the return on that investment on the back end through increased sales under the manufacturer's patent rights.

Although the invention is applicable to clinical trials for all types of medical products, we discuss only pharmaceutical clinical trials in detail. Trials for pharmaceutical approval are longer and more expensive than surgical instrument and medical implant trials because of the increased complexity of managing a drug's pharmacokinetic and pharmacodynamic interaction with the human body. Currently, the average drug candidate moves slowly through the FDA-mandated process of establishing dosage and proving its efficacy and non-toxicity. A pharmaceutical company must present the FDA with data from each of the 3 or 4 distinct trial phases described below:

a) Preclinical research: This phase typically involves years of experiments in animals and human cell cultures. If this stage of testing is successful, a pharmaceutical company provides this data to the FDA, requesting approval of their Investigational New Drug application (IND) to begin the 3-phase clinical trial process for testing the drug in humans.

b) Phase I Study: Phase I studies are primarily concerned with assessing the drug's safety. This initial phase of testing in humans is done in a small number of healthy volunteers (20 to 100), who are usually paid for participating in the study. The study is designed to determine what happens to the drug in the human body—how it is absorbed, metabolized, and excreted, and any side effects that occur as dosage levels are increased. This initial phase of clinical testing typically takes several months. About 70% of experimental drugs pass this initial phase of testing.

c) Phase II Study: Once a drug has been shown to be safe, it must be tested for initial efficacy. This second phase of clinical testing may last from several months to two years, and involve up to several hundred patients. The purpose of this study is to provide the pharmaceutical company and the FDA with comparative information about the relative safety of the new drug and its effectiveness. About 50% of drugs that enter advance past Phase II studies.

d) Phase III Study: These studies test drugs in several hundred to several thousand patients to provide the pharmaceutical company and the FDA with a statistically-significant understanding of the drug's effectiveness, benefits, and the range of possible adverse reactions. These studies typically last several years. 70%-90% percent of drugs that enter Phase III studies successfully complete this phase of testing. Once a Phase III study is successfully completed, a pharmaceutical company can request FDA approval to market and sell the drug within the United States.

e) Phase IV Study: These post-approval studies track a subset of the patient population taking the drug to observe the long-term effects and interactions of the drug and/or to study the agent's other potential medical benefits. These trials can be mandated by the FDA (especially for those drugs given conditional Phase III approval) to provide additional data on the drug's safety and efficacy profile, or they can be sponsored entirely by the pharmaceutical company in an attempt to discover additional, profitable clinical applications for the drug. Drug companies may also conduct Phase IV trials in order to collect data for over-the-counter (OTC) approval, which would greatly increase the market for the drug.

Technological advances are desperately wanted in clinical trial management. Almost all trial processes are still conducted with traditional manual recording, faxing, and file storage of paper-based data. These processes present substantial problems to the management of clinical trials, including:

1) Poor visibility into trial progress. Trial managers do not have real-time access to critical decision-making data, because of the manual nature of data and analysis. Trials have been run incorrectly for months or years, at a cost of millions of dollars to the sponsor. Also, the inaccessibility of paper data creates long delays when the trial data need to be queried.

2) High personnel requirement. Paper data require that people manually manage the physical flow, collation, and filing of information. In addition, clinical trial personnel must frequently travel to the trial sites to verify that on-site paper filings are being correctly managed.

3) Increased inaccuracy. Currently, paper forms are transferred to a central location, at which point, the data are manually entered via transcription into a central database. This process is both error-prone as well as physically and temporally removed from the actual patient visit.

Conventional digital data management solutions have been limited, and have consisted of proprietary, client-server, or offline databases, which are not integrated with one another or with other clinical systems. Many pharmaceutical and device companies have one or more of these so-called “legacy” systems in-house. There is a large opportunity to introduce digital information technologies into the trial management processes and affect the underlying system economics of drug development.

Contract research organizations (CROs) provide an economy-of-scale response to reduce risk and cost. The almost 600 CROs in the U.S. offer services aimed at accelerating the clinical trial process and controlling trial cost and risk for pharmaceutical development organizations. Although many pharmaceutical companies have some in-house clinical trial staff, most prefer to concentrate primarily upon research and outsource the labor-intensive projects such as site management and document processing to the heavily-staffed CROs. In 1998, U.S. pharmaceutical companies spent $5.5 billion on CROs, 57% (or $3.1 billion) of which was spent managing Phase I-IV clinical trials and preparing new drug applications (NDA). The remainder of outsourced CRO costs are attributable to the more analytical work of biostatistical analysis and trial design.

Although CROs increase overall trial efficiency and reduce pharmaceutical company investment in in-house personnel and trial IT (information technology) by providing custom software tools for use in trials, the structure of CRO service still leaves significant cost and risk to be borne by pharmaceutical companies. The CROs' own internal labor-intensive inefficiencies, which include costly training, heavy staffing, and the development of single-use IT systems, require high initial expenditure in the face of uncertain trial results. Most still use paper-based/faxed communications to manage data—requiring handling by several middlemen and the use of error-prone manual data reentry. Although many CROs use digital information technology in some form, most use isolated, modular systems, or in many cases, single-use solutions developed on a per-trial basis, all with different data output capabilities and incapable of cross-communication. It is estimated that current end-of-trial data collection and compilation methods cause a 12 to 15 week delay in product launch.

The CROs pass their high cost of service through to the pharmaceutical companies in the form of an up-front payment for trial preparation. These payments are often non-refundable, so these initial investments, often comprising up to 50% of the total trial cost, represent significant risk assumed by the pharmaceutical company before the first data are even collected. The remaining fees are collected on a per-patient basis, with a per-patient cost often assessed even if the trial is stopped or delayed. Furthermore, by providing little or no real-time access to trial data, the current CRO trial management system limits pharmaceutical companies' ability to effectively respond to the ongoing trial. It is not uncommon for trials to be completed, at costs of millions of dollars, only to find that the data captured was statistically invalid or indeterminate.

The rate of scientific progress suggests that there will be a strong need for efficient trial management solutions in the next 10 years. It is estimated that, as the Human Genome Project and other genetic research programs reach completion in the next decade, the number of known chemical targets and pathways will jump from 500 to approximately 2000. We believe that a rapid development of a whole new generation of pharmaceuticals based on this new knowledge will create a boom in the clinical trial market and will place a large premium on quick, accurate, and efficient clinical trial management.

The FDA recently published two standards-setting documents for this emerging industry, the “Guidance for Industry Computerized Systems Used in Clinical Trials,” and the 21 CFR Part 11 document on “Electronic Records and Electronic Signature Rules.” Industry analysts say that the FDA is hesitating to create regulations for this nascent market, but is instead adopting a policy of advising from the sidelines and indicating the general direction in which it would like the industry to move.

B. Internet-Based Clinical Trial Management

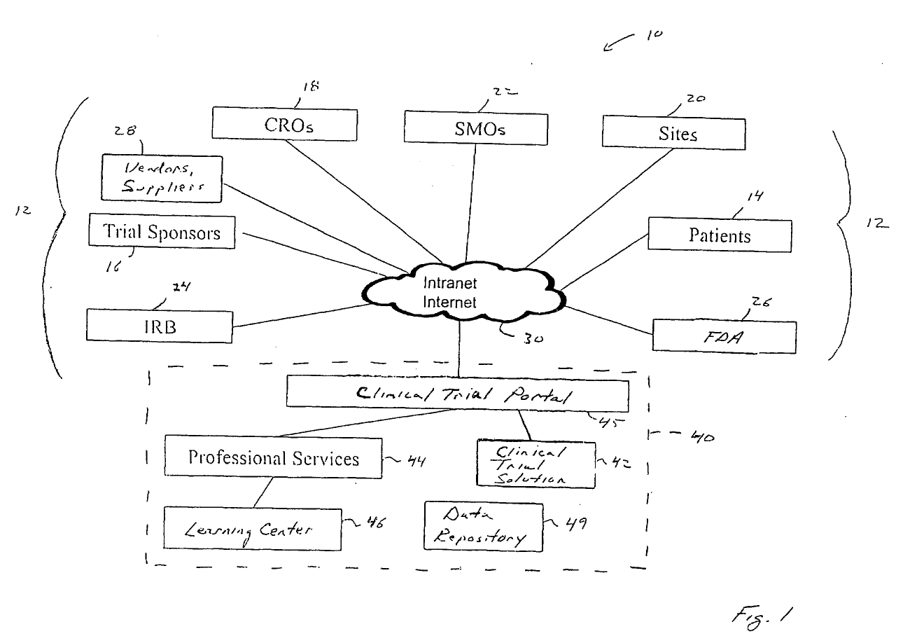

Referring to FIG. 1, a clinical trial community 10 includes a variety of trial participants that together comprises a user base 12. The participants include patients 14 involved in the testing of the medical product (e.g., a medical device or implant or a drug) undergoing trial, one or more sponsors 16 of the trial, and contract research organizations (CROs) 18. User base 12 also includes the trial sites 20 and site management organizations (SMOs) 22, as well as various review boards (IRBs) 24 and the FDA 26, and various vendors and suppliers 28.

The present invention provides a set of Internet-based software and services that streamlines the management of clinical trials by enabling participants 14-28 to use the Internet, alone or in combination with one or more intranets or other private networks (collectively denoted with reference numeral 30), to communicate with each other and with a management center 40 to store and obtain data generated during the clinical trial, as well as to manage and analyze that data, and produce comprehensive, organized, up-to-date reports on the progress, and results of the clinical trial.

Internet/intranet 30 includes the well-known publicly available communication network, which interconnects computers at universities, government/military offices, research centers, and businesses through the world, as well as the worldwide web of communication protocols and information distributed over the network. We also mean to include, however, private networks such as various “intranets” that are connected to and communicate with the publicly available network.

Moreover, although users 14-28 are represented by individual boxes in FIG. 1, it is contemplated that various users 14-28 may be part of an intranet or one or more other private networks connected to the Internet.

As is known, users of Internet/intranet 30 can access information in the form of documents or pages via graphical web browsers installed in the users' 14-28 computers. Like other distributed computer applications, the web is based on the client/server model, in which web pages reside on host computers that “serve up” pages on request by a user's 14-28 computer.

Functionally speaking, management center 40 comprises a web site that includes three basic components—clinical trial solution 42, professional services module 44, and learning center 46, all of which have access to a data repository 49. The hardware (e.g. host computers which operate as web servers) and software that implement the functionality of components 42-46 may be at a single physical location, or may themselves be part of a network, such as a local intranet. Indeed, the components of management center 40 may be distributed over Internet/intranet 30. Users 14-28 efficiently communicate with management center 40 via Internet/intranet 30 with standard, commercially available browsers. Thus, the added functionality at the users' 14-28 end is minimal, and the users' 14-28 computers are referred to as “thin clients” of the servers in web site of management center 40.

Management center 40 includes a clinical trial portal 45 through which user base 12 interacts with clinical trial solution 42, professional services module 44, and learning center 46. Clinical trial solution 42, professional services module 44, and learning center 46 collectively provide a suite of functionality and services that not only enable the clinical trial to be more efficiently run, but also allow user base 12 to access numerous ancillary services via Internet/intranet 30 and management center 40. Clinical trial solution 42 is discussed in detail below.

Professional services module 44 provides user base 12 with access to a host of services related to the conduct of the clinical trial. Examples include data assembly, data validation, and construction of reports in various user-defined formats. Additionally, these services comprise statistical analysis, training regarding CFR issues, and assistance regarding electronic implementation of business processes (e.g., QSR systems). In addition, professional module 44 provides user base 12 with access (via Internet/intranet 30) to other web sites to enable the user to obtain other services. Examples include ordering books and other informational materials from an on-line bookstore, making travel arrangements for visiting various sites 20 (FIG. 1) via on-line travel agencies, etc. Learning Center 46 supports numerous services indirectly related to the clinical trial. Examples include on-line help, and education on such non-medical product training topics as conferences, user groups, etc.

The comprehensive and flexible suite of Internet-based software and services provided via management center 40 streamlines the management of clinical trials, and provides users 14-28 with the flexibility to move clinical processes online at their own pace, one component at a time, with or without redundant systems. The secure, digital network provided by management center 40 via Internet/intranet 30 electronically links and warehouses data from all areas of a clinical trial, including case report forms, lab data reports, and medical images. Secure, web-based site-to-hub connectivity allows redundant data storage, and all information is protected by firewall and access-encoded encryption.

The Internet-based system 40 introduces a number of efficiencies into the clinical trial process:

Faster to Market: Currently, the process of data gathering analysis delays a trial's closure by approximately two months for each phase of a trial. The Internet-based system can reduce this to one day in each case, providing up to six months acceleration over the course of a three-phase trial. Currently, the average opportunity cost for delayed therapeutic agent is $1.3 million/day at peak sales.

Real-Time Decision-Making/Analysis: Current trials are 2-4 weeks out of date on basic information; unusual data requests can take up to two months to complete. The system permits same-day search and review of all trial data captured.

Fewer Personnel: The Internet-based system enables efficient, online, real-time monitoring of large volumes of trial data from the desktop, reducing necessary headcount, expense, and effort required to gather and manage data.

Improved Capital Structure: The Internet-based suite provides a pay-as-you-go transaction-based pricing system in place of the high, up-front payments presently required by the CROs & other vendors. This lowers the risks associated with drug development.

By introducing these efficiencies into the clinical trial process, the Internet-based approach to clinical trial management will significantly decrease the time, risk, and cost of clinical development.

1. Clinical Trial Portal

Clinical trial portal 45 provides each user who accesses management center 40 with an integrated view of the various concurrent processes involved in managing the clinical trial. The conventional clinical trial scenario is one in which numerous systems exist to solve the challenges of a trial. More often than not, these systems are stand alone systems that do not interchange data in a seamless manner. Systems range from trial design, to data capture, to project management, to financial monitoring and payments to statistical analysis, to regulatory submission creation. Because these systems act upon specific, distinct processes, different users typically use different systems. Exchanges of data from one system to another are quite cumbersome. Data is manually transferred between systems, at best. A need exists to tie all of these processes and users together with a seamless integration to facilitate ease of use, reduce learning curves and provide a quality of data that is unparalleled.

Clinical trial portal 45 provides such an environment in which users use a common interface to perform their tasks. Depending on the user and his or her access, the system reconfigures its interfaces to suite the use and the job at hand. The user is also given the freedom to manipulate and customize the system interfaces to make the experience personalized.

Clinical trial portal 45 uses Rules Based Access Control (RBAC) to validate whether a user is allowed to use a specific functionality, and if so, the parameters of such use. The data for RBAC is stored in a clinical trial database in data repository 49. Roles for the users are defined at the clinical trial setup time and through the trial lifecycle.

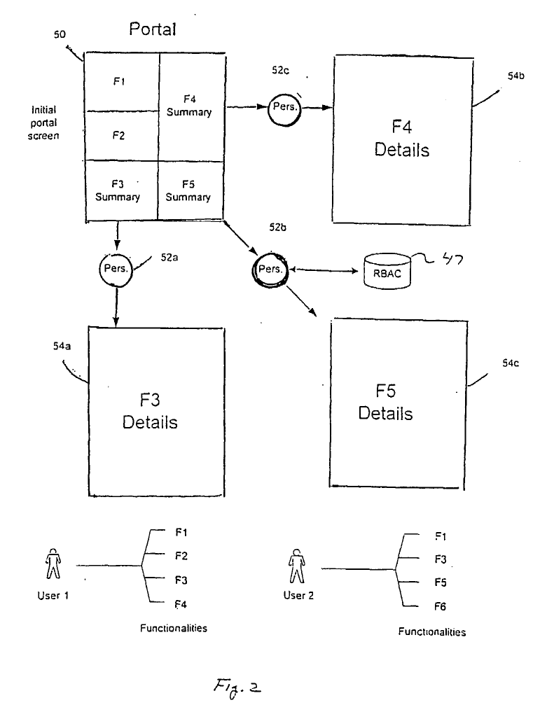

For example, referring to FIG. 2, clinical trial portal 45 presents each user with an initial portal screen 50 having areas that correspond to the functions (F) that the user is permitted to access, based on that user's defined role in the clinical trial (e.g., patient, site manager, etc.). For example, if there are six functions (F1-F6), and a user is only permitted access to functions 1-5, that user's initial portal screen 50 might look like that shown in FIG. 2.

The user may personalize (pers.) 52a-52c his or her initial screen to show only summaries of detailed functions (in this example, functions F3-F5). By selecting one of these functions (e.g. using a pointing device such as a mouse), the user is presented with screens 54a-54c, respectively, showing details of the selected functions.

RBAC 47 (stored in data repository 49) enables the system to alter the functionality presented to the user based on, e.g., the role of the user (such as patient 14, FDA 26 etc.). For example, person 1 shown in FIG. 2 may have access only to functions F1-F4, while person 2 may utilize only functions F1, F3, F5, and F6.

Users are “created” in the system by an administrative user and assigned specific roles within the community. As discussed above, each user can personalize his or her interface within their access rights. This setup and layout information is captured, stored (in the data repository 49, from FIG. 1), and reused the next time the user logs into the system. Users are assigned to one or more of the sites 20 (from FIG. 1). Sites in a clinical trial environment are typically hospitals or educational institutions that recruit patients.

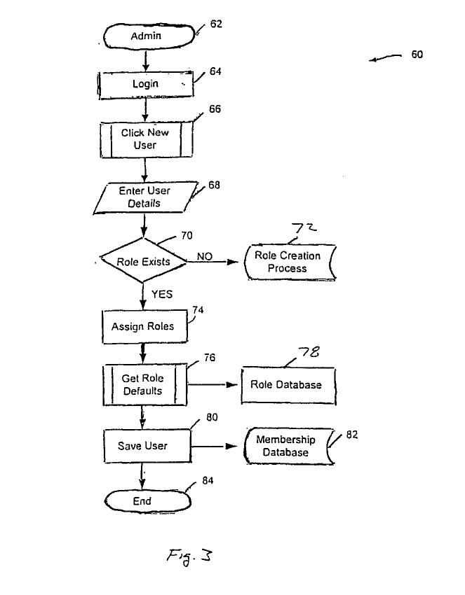

Referring to FIG. 3, the user creation process 60 is shown. Upon login 64, the administrative user 62 selects the “new user” option on a menu 66, and then enters details about this user 68. If a role 70 for that user does not exist, one is created 72 in the RBAC database. Then (or if a role already existed), the role is assigned 74 to that user and role defaults are obtained 76 by querying 78 the role database. The user's information is saved 80 by updating 82 a user membership database, and the process ends 84.

Consider, for example, a new user being created and assigned the “Study Coordinator” role. The role will have default personalization and entitlements to enable the user to perform his or her job efficiently. This user's portal view may have a “Query View” and a “Report View”. A collection of reports will be available to the user through the Report view to enable the user to play the Study Coordinator's role.

The membership and personalization application process will take common needs and uses of similar roles, and will use them to suggest roles access for easier setup and trial design. If the appropriate access role currently exists, the administrator assigns a role to the user. The application gets the defaults for that role and the defaults are recorded in the personalization membership database.

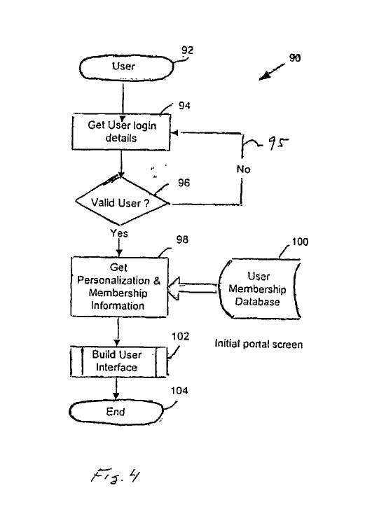

Referring to FIG. 4, whenever any user in user base 12 accesses the Internet-based system, he or she follows login process 90. If the login is accepted, the RBAC application queries membership information in the database (discussed above), and extracts information on how to configure the portal 45.

This is done by obtaining the user's 92 login details 94 and checking the membership database to determine if the user is valid 96. If the user is invalid, he or she is denied access. The user is given up to three tries 95 to input the correct login, after which he or she is denied access to the login page. If the user is valid, the system obtains personalization and membership information 98 from the user membership database, and builds the user interface 102. One aspect of the building step is the construction of initial portal screen 50 (FIG. 2). At this point, the user login process has ended, and the user has access to the functionalities provided to him by his access defined by the role (as discussed above). A designated administrator reviews current roles existing in roles library.

2. Network Topology

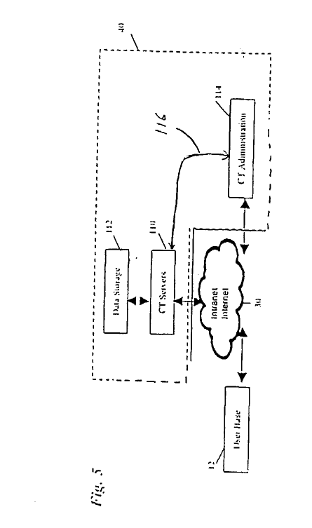

Referring to FIG. 5, functional components 42-46 (FIG. 1) of management center 40 are distributed between multiple clinical trial (CT) servers 110. The data generated during the clinical trial and communicated to management center 40 by user base 12 is stored in data storage 112 (in data repository 49). Clinical trial (CT) administration 114 also interfaces with user base 12 via Internet/intranet 30 for purposes to be described.

This network topology enables disconnected computing to manage user base 12, CT servers 110, and CT administration 114. This allows one to manage a global set of users, with CT servers 110 possibly located in one or more separate physical locations from CT administration 114. Thus, CT servers 110 may communicate with CT administration 114 directly via link 116 or over Internet/intranet 30.

Administrative users (which comprise CT administration 114) have various tools that allow remote configuration of the CT system. These tools enable a single point configuration for a variety of data capture instruments, as explained below, synchronize data capture to the workflow required for a clinical trial, and automatically configure the necessary links to store the captured data into the central data repository (shown as data storage 112 in FIG. 5). The administrator tools also include functionality to verify and validate the CT configuration of the remote servers at the users' locations.

CT servers 110 can exist as standalone machines, or can be scaled to a server farm architecture to provide more capacity and bandwidth. Applications may exist across machine boundaries or process boundaries. A high level of security is provided through internal and external security measures. CT servers 110 are scalable with respect to users, applications, and data.

Data storage 112 is implemented as a storage area network (SAN), which provides an easily scalable, redundant, transparent, secure, distributed, online/offline, network of distributed, managed storage infrastructure. This approach allows one to scale data without limitations of space, bandwidth, downtime, or scaling latency due to unavailability of infrastructure.

3. System Architecture

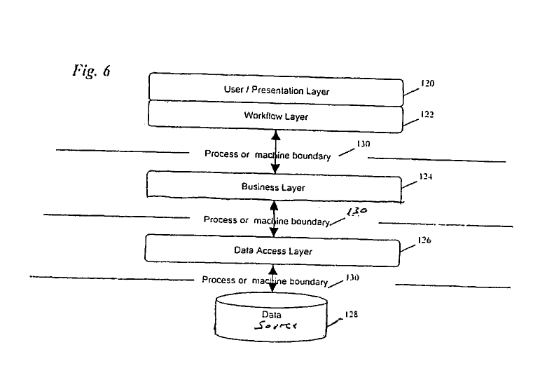

Referring to FIG. 6, the system that implements management center 40 is architected in a flexible, scalable, and extensible manner. The system is designed using an n-tier architecture. The four primary tiers are user/presentation layer 120, workflow layer 122, clinical layer 124, and data access layer 126. Data source 128 is accessed by data access layer 128. A data source 128 can be any data entry device, including a Web page, a PDA, a Wireless Phone, etc. This separation provides flexibility in distributing components across several machines or servers, which are depicted in FIG. 6 by process/machine boundaries 130.

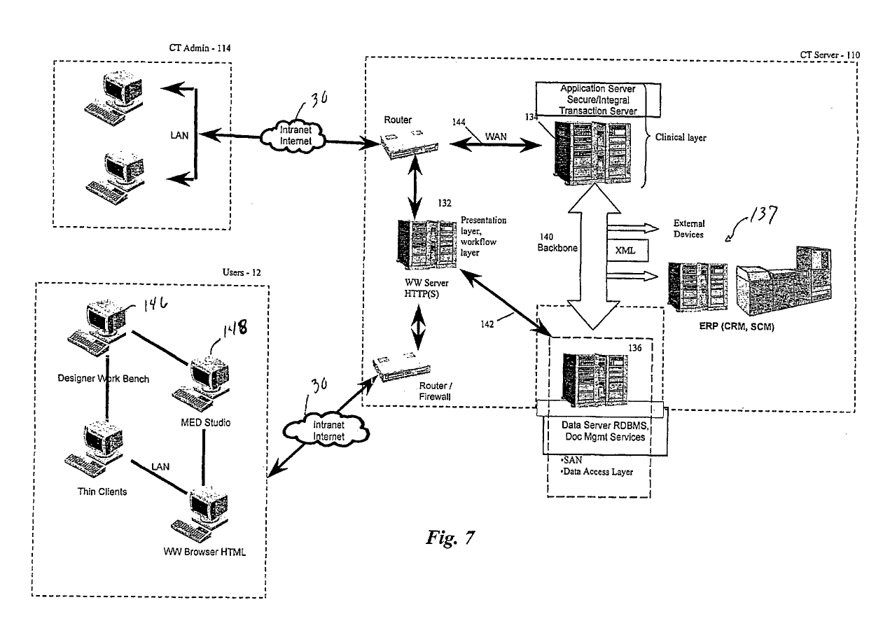

Referring to FIG. 7, the hardware that implements the functionality of layers 122-126 includes a plurality of servers. For example, WW server 132 carries out presentation and workflow layers 120, 122, application server 134 performs the functionality of clinical layer 124, and data server 136 implements data access layer 126. External devices 137 are, e.g., PDAs, Palm devices, patient monitoring devices, etc., which provide the user with information or capture information for use by the user. These devices may be hard-wired or wireless devices.

Servers 132-136 are each constructed according to a component based design. This approach provides for easy maintenance upgrade and scalability because any server 132-136 can be upgraded or replaced without disturbing the other servers.

In addition, the system components are loosely coupled via a backbone 140 and various wide area networks (WANs) 142, 144. This not only allows servers 132-136 to be located remotely from each other, but also means that replacing one component minimally affects the others, requiring little or no down time. A centralized, common repository, however, enables the efficient management of all collected data as well as managing access to functionalities exposed via addition of new components or hardware. The system also features staged performance tuning. When the system is built and deployed, the components can be tuned one at a time, thereby providing greater system reliability.

System functionality is scalable across process and machine boundaries. Several instances of the same application can be run on same machine. However, due to resource constraints on a particular server, integrated application components can be run on separate machines, thus distributing the load. Scalability is achieved by either adding resources to existing servers, e.g., by replacing the CPU with a faster one, increasing the physical memory on the servers, or adding new servers and balancing the load between the servers.

Reliability is addressed by using redundant server architecture. Each server has a “slave” duplicate server that is configured identically as its master. If the master suffers a failure, the slave picks up the masters activities and the user is unaware that a failure has occurred.

Security is provided by the applications themselves as well as an architecture that restricts use of the system to authorized users and authorized roles within the system. Internal security is provided by RBAC (rules based access control) and password-protected user login. External security is provided with digital certificates and a secure socket layer.

As described earlier, the clinical trial servers 110 communicate with the CT administration 114 and the users 12 over Internet/intranet 30. The users 12 include special user-operated tools systems, more particularly, a Designer Work Bench system 146 and a medical imaging system 148, which will be described below.

4. Functional Architecture

There are many parallel and serial processes going on in a clinical trial. The present system is easily extensible to accommodate these processes. The system provides component-based data flow. Distinct functional modules within the system manage distinct functions in a loosely-coupled manner. The primary functions are data capture, aggregation, transformation, and processing. The system enables many clinical trial functions, including but not limited to the following example.

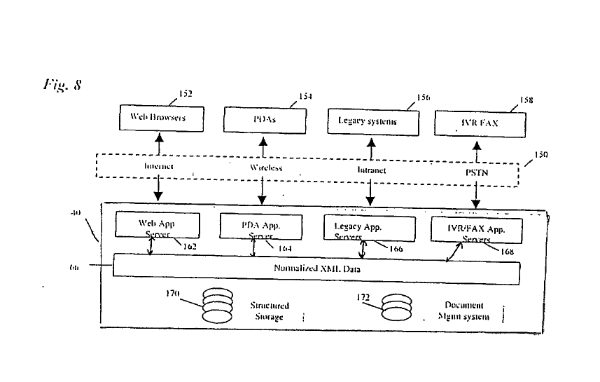

1. Data capture: Referring to FIG. 8, the system (management center 40) can accept various sets of inputs from a multitude of input devices which communicate with the functional components using a wide variety of communication protocols, which are collectively represented by network 150. For example, web browsers 152 communicate via Internet 30 (FIG. 1), while users that employ personal digital assistances (PDAs) 154 may use wireless transmission techniques. Legacy systems 156 may communicate via an intranet, while IVR/FAX devices 158 may exchange information with the system via PSTN devices. This mechanism enables the system to seamlessly integrate any current or future devices without modifying or implementing much of the existing system. Each particular input device has an associated application server component, specific to that protocol, provided by the system to understand the intricacies of the information. Thus, the system includes web application servers 162, PDA application servers 164, legacy application servers 166, and IVR/FAX servers 168.

The received information is marked up and transformed into a commonly understood language of the system by the user/presentation layer 66. That is, the information is reformatted from the format in which it was received to a common or “normalized” XML format that is the same for all of the different types of data capture servers 162-168.

Once marked into normalized form, the data is distributed by workflow and clinical layers 62, 64 for storage in data storage 52 (i.e., data repository 49). The stored data includes the actual data and its meta information for both structured data 170 and unstructured data 172, and is stored in data storage 112 (FIG. 5) via data access layer 66. The data access layer serves to abstract the type of data and its physical storage. Examples of data to be stores are documents, records in a database, charts, lab results. The access layer has the logic to identify the type of document and based on the normalized information, directs its storage appropriately. A document is stored in a document management system, whereas data from a web-based form is stored in the database. If a form is submitted as a document, however, then the document is stored in the document management system and the form data is stored in the database.

This design provides for a flexible, extensible architecture in which any system can utilize the clinical trial information or vice-versa. All incoming data is normalized and tagged to identify the type of source that originated the data before being stored into the database. Similarly, any data that needs to be rendered to an external system can be achieved by reversing the process. That is, the process works in reverse for data retrieved from data storage 170, 172 and transmitted to a destination (e.g., via devices 152-158). Based on how the retrieved data is tagged, application layer 66 reformats the data into a format suitable for the destination device type, and passes the data thereto via network 150.

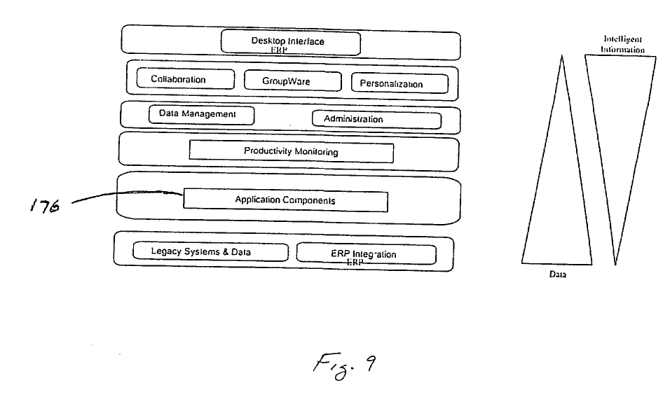

Referring to FIG. 9, application server 134 (FIG. 7) includes several functional modules, which are listed below along with a brief description of each module. These functional modules are carried out in application component layer 176 that assists in organizing large amounts of data (such as that obtained in a clinical trial) into a form more useful to the user—i.e., intelligent information. As shown in FIG. 9, once a user gains access to the system, e.g., via a desktop interface, he or she can collaborate with other users, perform groupware functions, and personalize his or her interface. Data management, e.g., data capture and storage, and administration functions such as enrollment, and user creation and monitoring, occur in a level closer to the system core than that accessed by most users. At a still deeper level, productivity monitoring functions are performed (e.g., tracking performance of activities within the clinical trial). Application components 176 (described below) are at the next level, above a level that permits integration with legacy systems and tie-ins with clients' existing ERP solutions.

All of these components work together to take the large amounts of raw data generated during a clinical trial and organize/analyze the data and present it to the user in a highly organized and analyzed way. As a result, the user obtains intelligent, useful information, rather than simply massive amounts of raw, possibly unfathomable data.

The various functional modules that reside in application component layer 176 are:

1. Project Management: This is a web based project management module that links resources, budgets and time with actual trial data. This module allows the creation of Gantt, Pert and other project management tools. The linking of project management with trial actuals provides an in-depth view of trial performance with respect to established baselines and slippage. As part of the information management, clinical trial parameters can be defined that could denote the health of the clinical trial or provide information that is important in decision making. These parameters are called Key Performance Indicators or KPIs.

2. Enterprise Resource Planning: This module provides a link to established ERP solutions such as SAP, BAAN to provide a bi-directional data exchange to better facilitate the pharmaceutical enterprise. This module performs the linking function at a departmental level, thereby tying HR, manufacturing, R&D, and accounting departments together to track cause and effect relationships among these centers at any pharmaceutical company.

3. Protocol Design: This is a workflow-enabled module that electronically mimics the collaborative environment required to design and obtain approval of a clinical trial protocol. This module establishes a process and tracks users, documents and signatures with respect to this process. The process workflow is customizable depending on the business process at a given pharma. The module also links various functional areas such as Bio-Statistics, QA, Medical Writers, FDA, etc.

4. CRF Design: This module provides a flexible tool for data capture design. The module functions to provide a drag and drop environment to create forms in WYSIWYG format that are filled out by physicians to collect clinical trial data. The tool allows for the visual development of form flow that addresses the unique visit schedule of clinical trials. This tool also facilitates the process of data validation, workflow and database creation. This tool also facilitates the multi-mode data capture through the use of the normalized data architecture discussed above. Once a virtual CRF is created, it can be rendered to the web via HTML, a Palm pilot, paper etc.

5. Recruitment: Subject recruitment is an arduous task. This module allows web-based selection of subjects who satisfy the clinical requirements of a clinical trial. The subjects or their physicians can enter the data to qualify the subjects. Once entered this data is reported to the clinical trial manager to facilitate the process of subject enrollment. This module also provides the necessary interfaces to exchange data from external sources from third party vendors.

6. Site Management: Sites that enroll subjects need to be up to date with FDA regulations. This module provides a set of tools to facilitate regulatory compliance as well as provide sites with management tools such as a searchable patient database, a financial calculator to keep track of payments due to the site, a safety database to keep records of adverse events that occurred at that site, etc.

7. Report Generation: Trial managers generate reports to keep up to date with trial actuals. This module provides users with flexible reporting capabilities such as standard reports, customizable reports, ad-hoc reports, and a report scheduler that allows users to personalize when they receive reports.

8. Document Management: This module provides a core 21 CFR Part 11 compliant document management solution that tracks versions, provides check-in, check-out functionality, etc. The module also contains a workflow component to facilitate business processes of a trial or a sponsor. Workflows for document approval can be modeled so that the necessary signatures and approvals are electronically captured and stored with audit trials. The module also provides centralized storage of documents pertaining to a drug or device forming a Master Drug (Device) Record.

9. Patient Diary : Certain trials require that patients monitor themselves and record data into a paper diary. This module provides subjects with an electronic diary that captures data and submits the data to the central database in a real-time manner.

10. IVR: Interactive voice response (IVR) systems are used as an alternative form of data entry. This module provides an automated solution to capture data using IVR. The system interfaces with the central database to store data centrally. A form design tool called as the “Designer Work Bench”, the DWB, ties in to provide some of the automation.

11. Laboratory Data: This module allows for the automatic capture of electronic data from lab devices such as blood gas analyzers, and urine analyzers. The data is then stored in the central database.

12. Image Management: Medical images are becoming increasingly more important for clinical trials. This module provides a set of tools to manage, analyze and store medical images. A software product provided by Enmed, the present assignee, called “MEDStudio”, which runs on the medical imaging system 148 (FIG. 27), is closely integrated with this module. MEDStudio is a stand-alone imaging software product, built by Enmed. MEDStudio when installed interacts with the clinical trial server by authenticating the user with it and uses the normalized information to download images from the clinical trial server. The imaging software then analyzes the image(s) and returns the results of such analysis, which can include information such as measurements, analytical data and the like, to the clinical trial server. The clinical trial server enters the information into the clinical trial database. The imaging software and the clinical trial server use a secure Internet link and work through firewalls.

13. Audit & Log: One of the most important pieces of data that is required by the FDA is an audit log, which is generated by this module. This core system provides guaranteed logging service so that log activity is not missed even when the system crashes, or power is lost. All applications within the system have access to this facility. The clinical trial server captures and maintains in the audit log information about changes to the data entered into the clinical trial server. The information includes key information to indicate, for example, user that changed the data, date when changed, original data, changed data and other information. This information thus serves to create an audit trail (and is referred to as an “Audit Trail”) and is used to track changes in data within the clinical trial management center 40.

14. Adverse Event Management: Adverse events are unforeseen medical emergencies that require immediate attention by a physician and require regulatory follow-up. This module provides a customizable workflow to adapt to the business processes at a pharma and the consequent reporting to the FDA.

15. Statistical Analyses: This module provides a link between the database and a statistical analysis engine (SAS) to allow data to be analyzed according to a given schedule. The user is provided with scheduling functions to flexibly set a time to analyze a data set. The user is also given tools to select what data to extract.

16. Financial Analyses: Clinical trials require a large amount of financial resources. This module provides customizable billing functionality, so that all parties participating in a trial, including pharmas, CRO, SMO, Sites, Statistical consultants etc., are billed based on configurable pricing plans.

5. Data Flow Pipeline Architecture

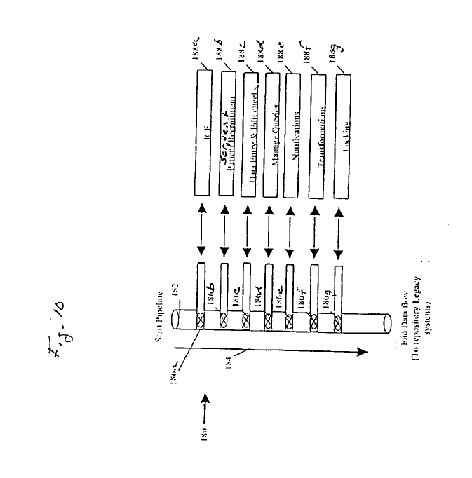

Referring to FIG. 10, workflow layer 122 (FIG. 6) implements a clinical data interchange pipeline (CDIP) 180 that enables clinical trial participants in user base 12 to exchange information electronically. CDIP 180 packages and transports clinical data objects from one application to another, over local-area network (LAN), wide-area network (WAN), Value-Added Network (VAN), or the Internet. CDIP 180 supports clinical trading scenarios, including purchasing and supply-chain purchasing.

The Clinical Data Interchange Pipeline (CDIP) architecture suggests that you can transmit any data object to any application using any transport protocol, by mixing and matching interoperable, standardized components. CDIP 180 interoperates with several transport systems such as e-mail and HTTP, as well as with currently existing systems.

CDIP 180 exposes Component Object Model (COM) interfaces so that developers and third-party vendors can create compatible components and easily link them together into any desired configuration. The architecture of CDIP 180 allows components to be developed independently of transport protocols and of specific data formats.

Any application, including accounting and clinical database applications, can use CDIP 180 simply by creating and executing a pipeline 182. CDIP 180 is both data-format independent and data-transport independent. Because CDIP 180 provides a common interface, users can take advantage of a wide variety of components, whether included with CDIP 180 or provided by third-party vendors, to conform to the protocols required by any other enterprise.

CDIP 180 is a free flowing set of clinical data in a particular direction 184. Information can be intercepted throughout its flow in the system. Each pipeline 182 has nodes 186 that can be used to direct information flow out of the pipeline to modules 188 to process the data and to add value. Each node 186 can also run a script/program to act on the flowing information. These programs or scripts can be pre-defined to be chosen at the pipeline definition time. Any number of nodes 186 can be inserted into the pipeline and any script can be attached to modules 188 in any order.

For example, consider the use of pipeline 180 to handle the enrollment of a patient in the clinical study by a study coordinator at a site 20 (FIG. 1). Node 186a runs a script in module 188a to confirm with the patient that he or she consents to participate in the trial. Node 186b accesses a module 188b that runs a patient screening script which prompts the study coordinator to enter basic patient information (e.g., sex, age, height, weight, smoker/non-smoker, etc.) Screening 188b applies rules to the patient data to determine if the patient is qualified to participate in the clinical trial (e.g., whether he or she is in the correct age range for a drug undergoing trials.

If the patient is qualified, the module 188b runs a recruitment script. The study coordinator is prompted to enter additional information (such as the results of a physical examination). Further along pipeline 180, node 186c accesses module 186c that processes patient data that has not previously been validated. Module 188c applies edit check rules to that data and to the results of the patient's examinations throughout the course of the clinical trial.

Other nodes 186d-186g access modules that perform scripts on the patient's data to add further processing value. The modules manage queries (188d), send out notifications (188e) (e.g. that data has changed or that another visit to a clinical site is to be made), as well as perform data transformation (188f) and locking (188g). Data transformation 188f is the process of converting data from one or more formats into another format which is wholly or part of the original set of data. When all the data for a patient has been verified, locking 188g locks the patient's data to prevent any further modifications to the data.

CDIP 180 provides a flexible way of designing a library of predefined information processing nodes, which support a common interface and can be extended upon to perform customized tasks or add new interfaces to be used at these nodes.

The pipelined data flow architecture supports numerous functional features, among which are the following:

1) Intelligent Data: This is a normalized set of information (see FIG. 9) that can be used to input and output to and from external systems, and provides an extensible architecture in which any system can utilize the present system's clinical trial information or vice-versa. All incoming data is normalized (as discussed above) and tagged before being stored into the database.

2) Knowledge Management: Information is captured as trials are performed using this system Information about the trial process, user performance, drug indications via statistical tests, various approved documents etc are captured and stored with meta information. This information can be searched and analyzed at a later time, to help in formulating better trials, processes or identify trends across trials.

3) Imaging Workflow in Clinical Trials: The management of clinical trial imaging data with a configurable workflow engine adapted to communicate using DICOM 3.0 as a base protocol to manage and track tens of thousands of images according to FDA requirements. Each trial using medical imaging data requires various stages of data validation, analysis, and review. The workflow component is used to graphically develop these stages and as each patient and their images enters the pipeline, the configured workflow is used to process the image data and store the results captured at each stage. This process can be done remotely with radiologists logging in and viewing the images in a browser and their responses captured immediately.

4) Integrated Clinical Trial Data Repository/Portal: A portal that provides an integrated view of the various concurrent processes involved in managing a clinical trial. Stages that are included range from protocol design to data capture to project management to financial monitoring and payments to statistical analysis to submission creation.

5) 21 CFR Part 11: A set of tools for the validation of conformance to 21 CFR regulations. The tools will analyze computer systems against various requirements of the CFR guidelines and generate a report. The tools will work in a client server and a web based environment.

6) eNDA creation from the data repository: This is a software module which manages the creation of an electronic submission to the FDA as per their guidelines.

7) ASP model for Clinical Trial Execution: The demands of using an ASP model from a technology standpoint with respect to FDA regulations require unique architecture designs. The design focuses on providing the reliability, availability, scalability and security expected with an ASP without compromising on speed due to FDA requirements.

8) Linked Project Management with performance metric in real time during clinical trial execution: The clinical trial process today faces many challenges with respect to real time project management. The unavailability of real-time data and the appropriate metrics to monitor the incoming data and relating this information to a project plan is non-existent. The solution incorporates and integrates this information along with personnel resources and trial budgets in an easy-to-understand and interactive manner that allows for a better-managed clinical trial.

9) Designer Workbench: This tool, which runs on the Designer Work Bench system 146 (of FIG. 7), serves to automate the setup of a clinical trial and reduce the effort required to set up a clinical trial for a variety of execution models including the ASP model. The tool allows the user to design a clinical trial without respect to data capture mechanisms (Web, Handheld, paper, fax etc.). The tool automates the creation of the necessary interfaces for data capture, cross usage validation rules, and workflow with respect to data coming from disparate desperate sources. The tool also has an intelligent database design mechanism that automatically generates database schemas and completely eliminates the need to create databases manually. The tool also performs these actions remotely. The tool is also self-validating to ensure compliance with FDA regulations.

10) Data Rendering Engine: This component generates a variety of outputs from a normalized data feed. That is, this component generates HTML, WML, TIFF, PDF, etc. formats from a common data source such as a database table.

A number of embodiments of the invention have been described. Nevertheless, it will be understood that various modifications may be made without departing from the spirit and scope of the invention. Accordingly, other embodiments are within the scope of the following claims.

What is claimed is:

1. A method for managing a clinical trial, comprising:
enabling information exchanges over an Internet-based network with users participating in a clinical trial;
deploying over the Internet-based network for use by the users clinical trial setup information including tools to automate creation of a data repository;
providing to the users over the Internet-based network, collaborative clinical trial setup and administration functions which allow the users to use the clinical trial setup information to collaborate with each other and administer the clinical trial; and
performing clinical trial management functions to add intelligence to clinical trial data received in the information exchanges.

2. The method of claim 1, further comprising:
capturing the clinical trial data in different formats from a plurality of data sources;
transforming the clinical trial data from the different formats to a common format for storage in the data repository; and
converting the clinical trial data stored in the data repository from the common format to another format suitable for a receiving device operated by a user to receive such clinical trial data.

3. The method of claim l, further comprising:
providing processing nodes sharing a common interface and adapted to communicate with applications having different interfaces; and
organizing the processing nodes into a pipeline structure to support a flow of clinical data objects in a given direction, each processing node within the pipeline structure using the common interface to allow the flow of the clinical data objects to be directed out of the pipeline to one of the applications for processing and reintroduced into the pipeline structure through that node.

4. The method of claim 1, further comprising:
generating an audit trail to track changes in the clinical trial data.

5. The method of claim 1, further comprising:
enabling the users to customize workflow related to processing of the clinical trial data.

6. The method of claim 1, further comprising:
defining clinical trial parameters to denote aspects of clinical trial performance; and
updating the clinical trial parameters during the clinical trial on a real-time basis.

7. The method of claim 2, wherein converting converts the clinical trial data from a common format to different formats for rendering to user-operated devices of different form factors.

8. The method of claim 1, further comprising:
associating with each user a username and password;
assigning to each user a clinical trial role and trial site;
using the username and password to validate each user for authentication at a level of data access; and
using the clinical trial role and trial site to validate each user for authentication at a different level of data access.

9. A data interchange method, comprising:
providing processing nodes sharing a common interface and adapted to communicate with applications having different interfaces; and
organizing the processing nodes into a pipeline structure to support a flow of data objects in a given direction, each processing node within the pipeline structure using the common interface to allow the flow of the data objects to be directed out of the pipeline to one of the applications for processing and reintroduced into the pipeline structure through that node.

10. A method of operating a medical imaging system in a clinical trial environment having a clinical trial server for storing clinical trial data from users participating in a clinical trial, comprising:
communicating with the clinical trial server to download images from among the stored clinical trial data;
authenticating users into the clinical trial system based on user privileges associated with the users;
analyzing the images; and
providing results of the analyzing to the clinical trial server over a secure Internet link for integration with the stored clinical trial data.

11. A clinical trial management system, comprising:
an application server configured to perform clinical trial management functions;
a Web server coupled to the application server and having an interface to facilitate access to the clinical trial management functions over an Internet-based network by users participating in a clinical trial; and
wherein the interface controls access to the clinical trial management functions by each user according to dynamic access rights associated with a clinical trial role assigned to the user.

12. A clinical trial management system, comprising:
an arrangement of servers capable of responding to user requests from users participating in a clinical trial, the arrangement being scalable to serve an increasing number of the users concurrently by coupling additional servers; and
wherein the arrangement maintains user session information in a database tier to provide for load sharing between at least two of the servers.

13. A clinical trial management system, comprising:
a server for capturing clinical trial data from users participating in a clinical trial; and
a graphical interface, coupled to the server, to allow the users to customize workflow related to processing of the clinical trial data.

14. A computer program product residing on a computer-readable medium for managing a clinical trial, the computer program comprising instructions causing a computer to:
enable information exchanges over an Internet-based network with users participating in a clinical trial;
provide to the users over the Internet-based network collaborative clinical trial setup and administration functions which allow the users to use clinical trial setup information to collaborate with each other and administer the clinical trial; and
perform clinical trial management functions to add intelligence to clinical trial data received in the information exchanges.

15. The computer program product of claim 14, further comprising instructions causing a computer to:
generate an audit trail to track changes in the clinical data.

16. The computer program product of claim 14, further comprising instructions causing a computer to:
enable the users to customize workflow related to processing of the clinical trial data.

17. The computer program product of claim 14, further comprising instructions causing a computer to:
define clinical trial parameters to denote aspects of clinical trial performance; and
update the clinical trial parameters during the clinical trial on a real-time basis.

18. The computer program product of claim 14, further comprising instructions causing a computer to:
transform clinical trial data from different formats to a common a for storage in a data repository; and
transform the clinical trial data from the common format to different formats for rendering to user-operated devices of different form factors.

19. The computer program product of claim 14, further comprising instructions causing a computer to:
associate with each user a username and password;
assign to each user a clinical trial role and site;
use the username and password to validate each user for authentication at a level of data access; and
use the clinical trial role and site for authentication at a different level of data access.

20. A computer program product residing on a computer-readable medium for enabling clinical data interchange, the computer program comprising instructions causing a computer to:
provide processing nodes sharing a common interface and adapted to communicate with applications having different interfaces; and
organize the processing nodes into a pipeline structure to support a flow of clinical data objects in a given direction, each processing node within the pipeline structure using the common interface to allow the flow of the clinical data objects to be directed out of the pipeline to one of the applications for processing and reintroduced into the pipeline structure through that node.

21. A computer program product residing on a computer-readable medium for operating a medical imaging system in an clinical trial management environment, the computer program comprising instructions causing a computer to:
communicate with a clinical trial system that captures and stores trial data from users participating in a clinical trial to download images from among the stored clinical trial data;
authenticate users into the clinical trial system seamlessly based on user privileges associated with the users;
analyze the images; and
provide results of each analysis to the clinical trial server over a secure Internet link for integration with the stored trial data.

22. A computer program product residing on a computer-readable medium for managing documents in a clinical trial management environment, the computer program comprising instructions causing a computer to:
allow users to manage different versions of documents; and
attach documents to data entered through a clinical trial server.
